(19) United States
(12) Patent Application Publication
(10) Pub. No.: US 2010/0176216 A1
(43) Pub. Date: Jul. 15, 2010

(54) Convection Type Discharge-Irrigation Pipe

(76) Inventor: Chung-Yau Cheung, Hong Kong (CN)

Correspondence Address: Dr. BANGER SHIA;Patent Office of Bang Shia, 102 Lindencrest Ct., Sugar Land, TX, 77479-5201, US

(21) Appl. No.: 12/440,466

(22) PCT Filed: Aug. 18, 2008
(86) PCT No.: PCT/CN08/01482

§ 371 Date: Mar. 7, 2009

(51) Int. Cl. A01G 25/06

(52) U.S. Cl. 239/201

(57) ABSTRACT

A convection type discharge-irrigation pipe comprises an outer pipe, an inner pipe and a joint. The inner pipe is disposed in the outer pipe. Between the inner and outer pipes is defined outer discharge-irrigation channels, and an inner discharge-irrigation channel is defined in the inner pipe which can be triangle-shaped or rectangle-shaped in cross section. In a bottom of the outer pipe is defined a plurality of apertures. In both lateral surfaces and a bottom of the inner pipe is defined a plurality of apertures. The apertures defined in the lateral surfaces of the inner pipe enable the inner discharge-irrigation channel to be in communication with the outer discharge-irrigation channels. The apertures in the bottom of the inner pipe are aligned with the apertures in the bottom of the outer pipe. Thereby, such a discharge-irrigation pipe has the double function of discharging and irrigating water.

### BACKGROUND OF THE INVENTION

1. Field of the Invention

The present invention relates to a discharge-irrigation system, and more particularly to a convection type discharge-irrigation pipe for a discharge-irrigation system.

2. Description of the Prior Art

Conventional discharge-irrigation pipes usually absorb water in a capillary manner and are of loose mesh hoses added with filter sheet, and the design of the conventional discharge-irrigation pipes is such that the capillary apertures are used to stop external stone, mud and sand, and the water of the soil is collected into the pipe and then discharged out. Such conventional pipes can work at the beginning, after a long period time of use, however, sand or mud will accumulate and block the discharge apertures and the filter sheet, resulting in a malfunction of the irrigation pipes.

The present invention has arisen to mitigate and/or obviate the afore-described disadvantages.

### SUMMARY OF THE INVENTION

The primary objective of the present invention is to provide a convection type discharge-irrigation pipe using the three-hole type convection principle. When irrigating water, water flows into outer discharge-irrigation channels and is discharged from apertures defined in a bottom of an outer pipe. When discharging water, water flows into the apertures defined in the bottom of the outer pipe and is discharged from the outer discharge-irrigation channels. Thereby, the present invention can solve the problem of blocking the apertures, so as to achieve the best discharge-irrigation effect.

To achieve the objective of the present invention, the convection type discharge-irrigation pipe comprises an outer pipe, an inner pipe and a joint. The inner pipe is disposed in the outer pipe. The outer discharge-irrigation channels are defined between the inner and outer pipes, and an inner discharge-irrigation channel is defined in the inner pipe which can be triangle-shaped or rectangle-shaped in cross section. The apertures are defined in the bottom of the outer pipe. In both lateral surfaces and the bottom of the inner pipe is defined a plurality of apertures. The apertures defined in the lateral surfaces of the inner pipe enable the inner discharge-irrigation channel to be in communication with the outer discharge-irrigation channels. The apertures in the bottom of the inner pipe are aligned with the apertures in the bottom of the outer pipe.

Both ends of the inner discharge-irrigation channel of the inner pipe with a triangle-shaped cross section or the inner pipe with a rectangle-shaped cross section are sealed with a sealed head, respectively.

The inner pipe with a triangle-shaped cross section is solid and its lateral surface and bottom are defined with the apertures which are connected to one another via connecting holes.

The inner pipe with a rectangle-shaped cross section is solid and its lateral surface and bottom are defined with the apertures which are connected to one another via the connecting holes.

On upper and lower portions of an inner periphery of the outer pipe are formed separation ridges, respectively, which are defined with insertion channels for insertion of waterproof plates. Between the waterproof plates is the inner discharge-irrigation channel, and between the waterproof plates and the inner periphery of the outer pipe are the outer discharge-irrigation channels. A plurality of apertures is defined in an upper surface of the respective waterproof plates.

In the inner periphery of the outer pipe can also be equidistantly arranged a row of vertical discharge-irrigation pipes. The respective discharge-irrigation pipes have a lower end connected to the apertures defined in the bottom of the outer pipe and a top end defined with an open slot.

The joint comprises a pipe head and a connecting block which is fixed inside the pipe head. Both ends of the connecting block are shaped corresponding to the shape of the inner pipe, such that the connecting block can be inserted into or connected to the inner pipe.

The pipe head can be designed to be cylindrical connection type, cylindrical orthogonal-shaped, cylindrical tee-shaped, cylindrical seal-shaped or cylindrical one-way connection type.

The cylindrical one-way connection type pipe head is defined with an inner hole having a dilated or reduced section. A sealed ball is disposed in the dilated or reduced section, and restriction blocks are disposed at one end of the dilated or reduced section.

An A-shaped member is fixed inside the outer pipe. In both lateral surfaces of the A-shaped member are the corresponding apertures.

It is apparent from the above-mentioned descriptions that the present invention has the advantages described as follows: the convection type discharge-irrigation pipe has the effects of discharging and irrigating water by using the three-hole type convection principle, so that it not only has a reasonable structure and a long life, but also can save water and solve the problem of blocking the apertures.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an illustrative view showing an outer pipe with a cylinder-shaped cross section and an inner pipe with a triangle-shaped cross section of a convection type discharge-irrigation pipe in accordance with the present invention;

FIG. 2 is an illustrative view showing the outer pipe of FIG. 1;

FIG. 3 is an illustrative view showing the inner pipe of FIG. 1;

FIG. 4 is an illustrative view showing the solid column of FIG. 1;

FIG. 5 is an illustrative view showing the outer pipe with a cylinder-shaped cross section and an inner pipe with a rectangle-shaped cross section in accordance with the present invention;

FIG. 6 is an illustrative view showing the inner pipe of FIG. 5;

FIG. 7 is an illustrative view showing the solid column of FIG. 5;

FIG. 8 is an illustrative view showing the outer pipe with a cylinder-shaped cross section and an inner discharge-irrigation channel;

FIG. 9 is a perspective view of FIG. 8;

FIG. 10 is an illustrative view showing waterproof plates of FIG. 8;

FIG. 11 is an illustrative view showing the outer pipe with a cylinder-shaped cross section and a vertical discharge-irrigation pipe mounted in an inner periphery of the outer pipe;

FIG. 12 is a perspective view of FIG. 11;

FIG. 13 is an illustrative view showing a joint of the convection type discharge-irrigation pipe in accordance with the present invention;

FIG. 14 is an illustrative view showing a pipe head of the joint of FIG. 13;

FIG. 15 is an illustrative view showing a connecting block of the joint of FIG. 13;

FIG. 16 is an illustrative view showing the one-way connection type pipe head of FIG. 14;

FIG. 17 is an illustrative view showing the outer pipes being connected to each other by the joint;

FIG. 18 is an illustrative view showing an open slot being defined in a top end of the vertical discharge-irrigation pipe;

FIG. 19 is a side view of FIG. 18;

FIG. 20 is a cross sectional view of the convection type discharge-irrigation pipe taken along the line A-A; and

FIG. 21 is an illustrative view showing the outer pipe with a cylinder-shaped cross section and the A-shaped member in accordance with the present invention.

### DETAILED DESCRIPTION OF THE PREFERRED EMBODIMENTS

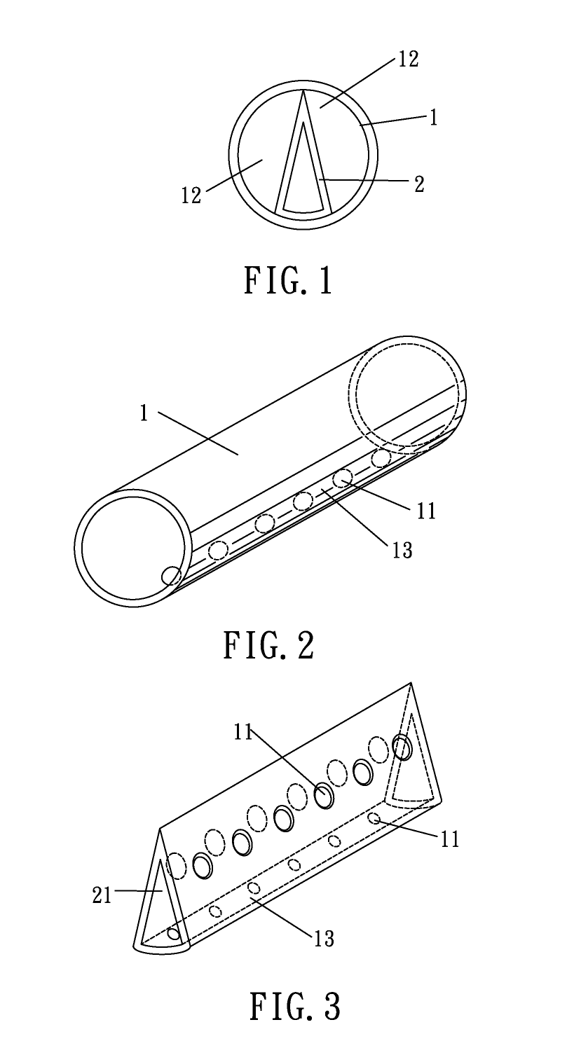

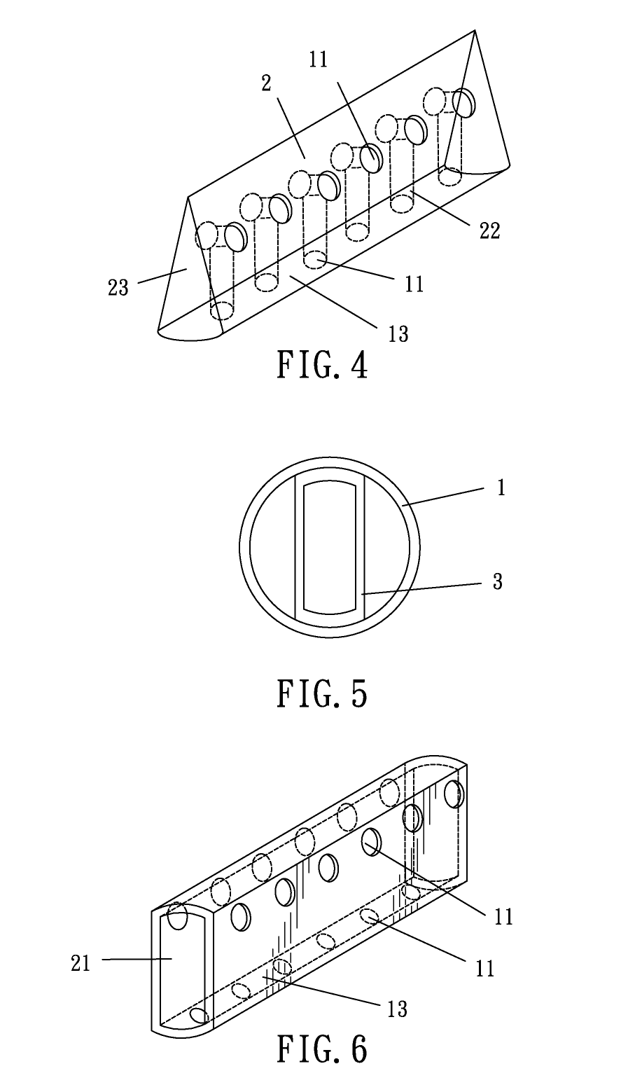

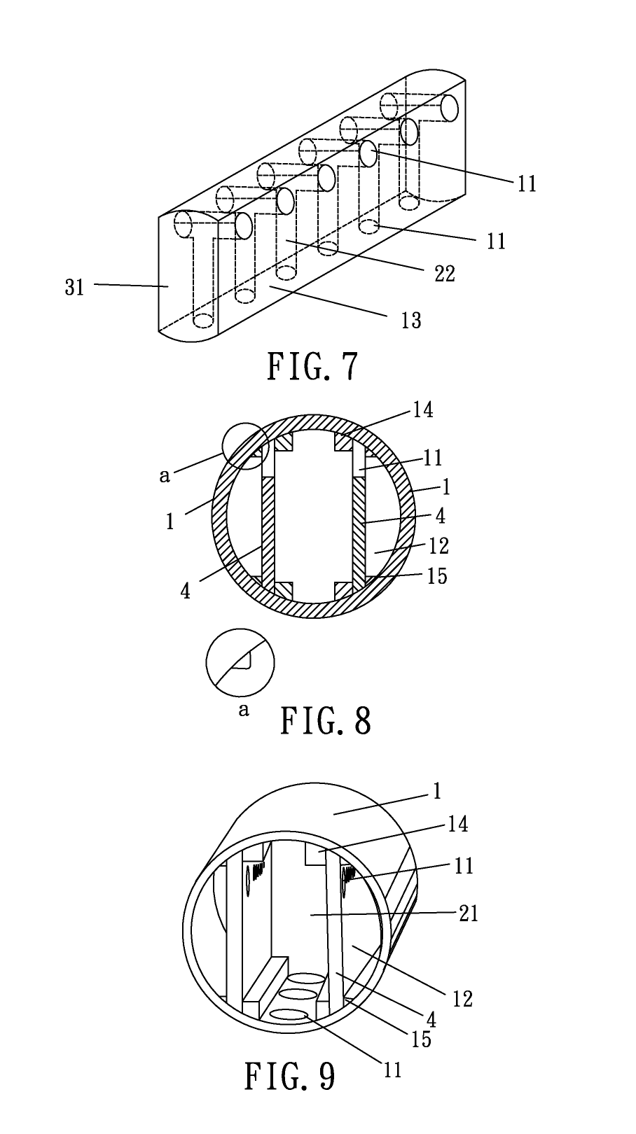

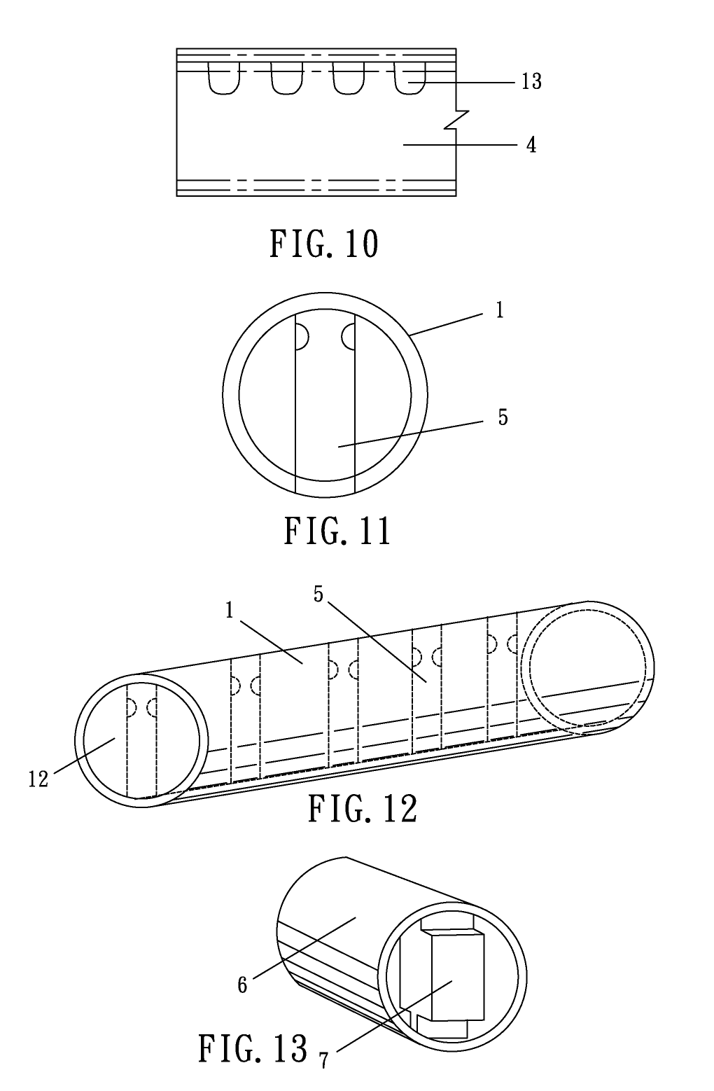

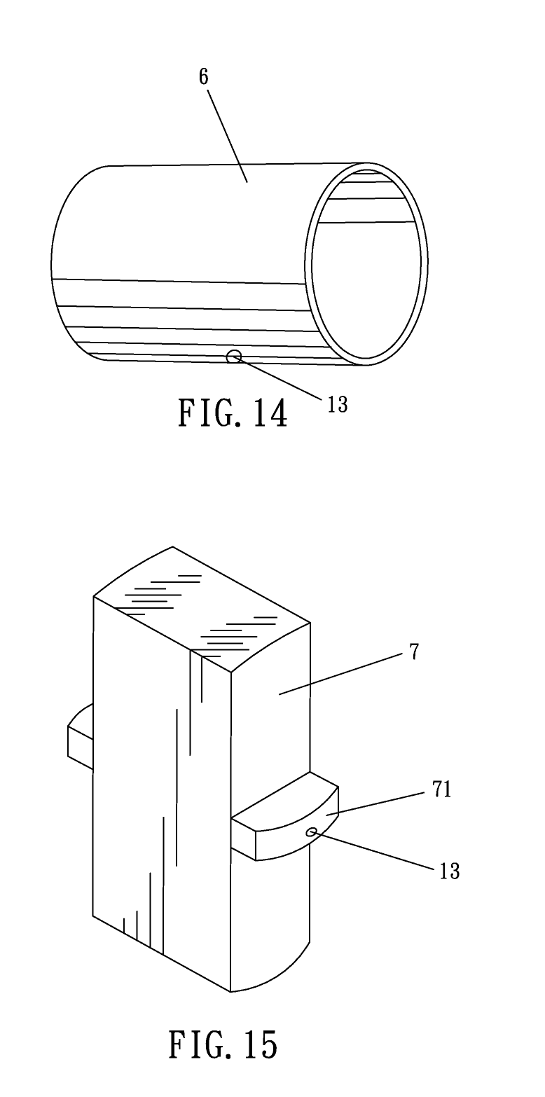

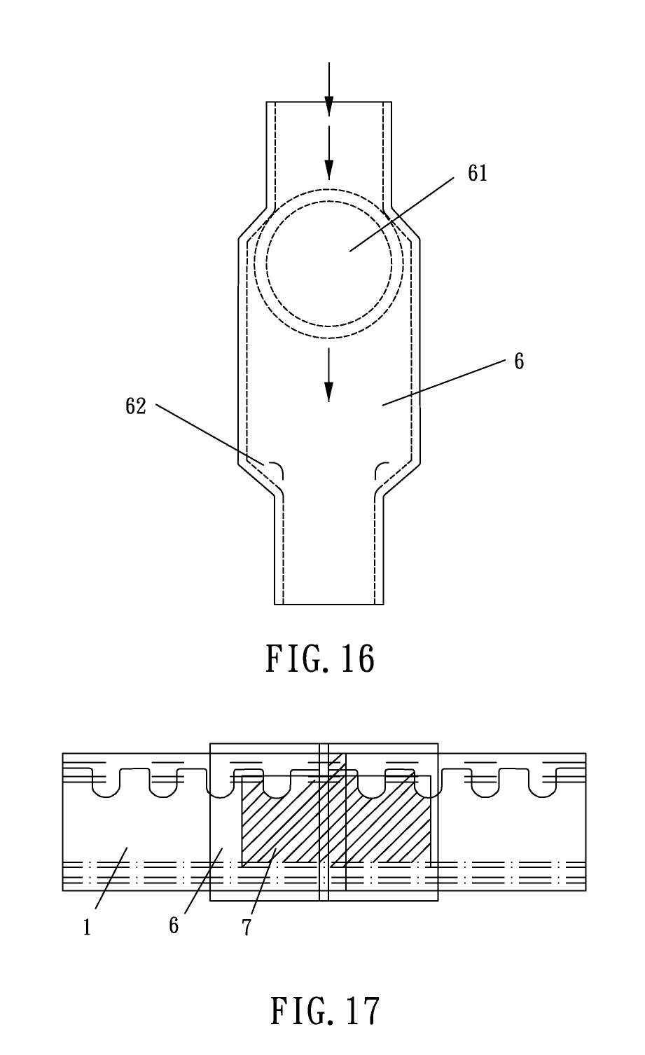

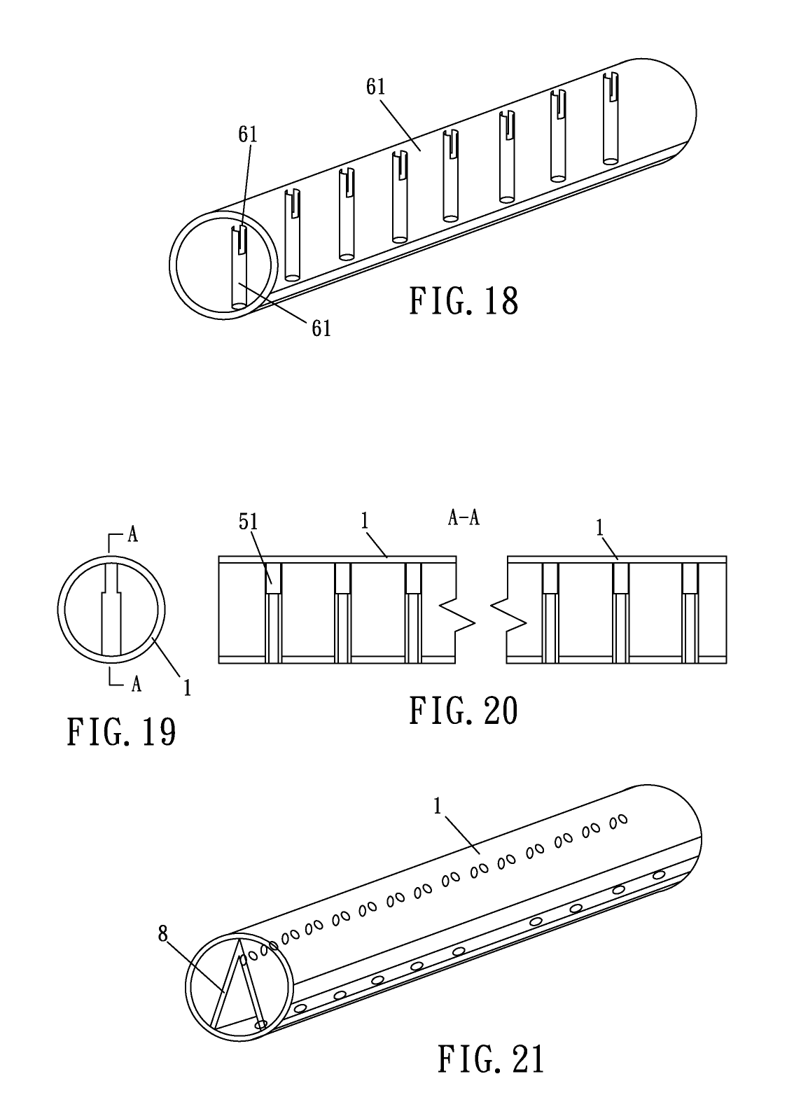

Referring to FIGS. 1-21, a convection type discharge-irrigation pipe in accordance with the present invention comprises an outer pipe 1, an inner pipe 2 with a triangle-shaped cross section, a inner pipe 3 with a rectangle-shaped cross section and a joint. The outer pipe 1 is cylindrical in cross section and can be made of PVC/UPVC pipe, galvanized pipe with inner coating, seamless steel pipe, stainless steel pipe, copper pipe or common galvanized pipe. The inner pipe 2 or the inner pipe 3 is fixed inside the outer pipe 1 via a screw hole 13. In a bottom of the outer pipe 1 is defined a plurality of apertures 11. In both lateral surfaces and the bottom of the inner pipe 2 and the inner pipe 3 is defined a plurality of apertures 11, respectively, and the apertures 11 in the bottom of the outer pipe 1 are aligned with the apertures 11 in the bottom of the inner pipe 2 or the inner pipe 3. Between the inner pipe 2 or the inner pipe 3 and the outer pipe 1 are formed outer discharge-irrigation channels 12. The inner pipe 2 or the inner pipe 3 has three designs, the first design is that the inner pipe 2 or the inner pipe 3 is defined with an inner discharge-irrigation channel 21, the second design is that both ends of the inner pipe 2 or the inner pipe 3 are sealed with a sealed head, respectively, and the third design is that the inner pipe 2 or the inner pipe 3 can be replaced with a triangular solid column 23 or a rectangular solid column 31. The apertures 11 defined in the lateral surfaces and the bottom of the triangular solid column 23 or the rectangular solid column 31 are connected to one another via connecting holes 22. The triangular solid column 23 or the rectangular solid column 31 has no inner discharge-irrigation channel 21. The outer pipe 1 can also be designed such that two inner separation ridges 14 and two outer separation ridges 15 are formed on upper and lower portions of an inner periphery of the outer pipe 1, respectively. Between the respective inner separation ridges 14 and outer separation ridges 15 is defined an insertion channel for insertion of a waterproof plate 4 having a plurality of apertures 11 defined in an upper surface thereof. Between the waterproof plates 4 is the inner discharge-irrigation channel 21, and between the respective waterproof plates 4 and the inner periphery of the outer pipe 1 are the outer discharge-irrigation channels 12. In addition, in the inner periphery of the outer pipe 1 can also be equidistantly arranged a row of vertical discharge-irrigation pipes 5. The respective discharge-irrigation pipes 5 have a lower end connected to the apertures 11 defined in the bottom of the outer pipe 1 and a top end defined with an open slot 51. The outer pipe 1 can also be designed such that an A-shaped member 8 can be fixed inside the outer pipe 1. In both lateral surfaces of the A-shaped member 8 are the corresponding apertures 11. Two outer pipes 1 can be connected to each other by the joint which comprises a pipe head 6 and a connecting block 7. The connecting block 7 is fixed to the pipe head 6 via the screw hole 13 defined in a restriction block 71. Both ends of the connecting block 7 are shaped corresponding to the shape of the inner pipe 2 or the inner pipe 3, such as, triangle-shaped and rectangle-shaped, such that the connecting block 7 can be inserted into or connected to the inner pipe 2 or the inner pipe 3. The pipe head 6 can be designed to be orthogonal-shaped or tee-shaped for facilitating assembly, and can also be of one-way connection type and has an inner hole with a dilated or reduced section. A sealed ball 61 is disposed in the dilated or reduced section, and restriction blocks 62 are disposed at one end of the dilated or reduced section, which permits the water to flow in one direction only.

Working principle:

1, the convection type discharge-irrigation pipe used as a discharge pipe:

Water firstly flows from the apertures defined in the bottom of the outer pipe into the inner discharge-irrigation channel of the inner pipe, and then is discharged from the outer discharge-irrigation channels via the apertures defined in the lateral surfaces of the inner pipe. Mud and sand are separated from water by the gravity effect. Since the mud and sand and the collected objects are greater in weight and density than water, naturally, the redundant water will be discharged from the outer discharge-irrigation channels via the inner pipe because of the pressure caused by water level difference between the outer pipe and the inner pipe.

2, the convection type discharge-irrigation pipe used as an irrigation pipe:

Water firstly flows from the outer discharge-irrigation channels defined between the outer and inner pipes into the inner discharge-irrigation channel of the inner pipe, and then is discharged from the apertures defined in the bottom of the outer pipe. The convection type discharge-irrigation pipe of the present invention is suitable to be imbedded in the ground to irrigate the roots of the plants growing in plain, desert, farmland and so on. The conventional rotary automatic sprinkler utilizes the injection type and throw type sprinkling methods or manual irrigation mode, and the pipes arranged around the periphery of the farmland to irrigate the plants. However, such methods cannot irrigate the plants completely because of sun radiation, wind direction and ground temperature. Contrarily, the present invention can achieve the best irrigation effect. For example, when the convection type discharge-irrigation pipe of the present invention is applied to irrigate the farmland, the plants can grow up tall under enough water supply, so as to achieve the effect of sand prevention.

While we have shown and described various embodiments in accordance with the present invention, it should be clear to those skilled in the art that further embodiments may be made without departing from the scope of the present invention.

What is claimed is:

1. A convection type discharge-irrigation pipe, comprising an outer pipe, an inner pipe and a joint, characterized in that: the inner pipe is disposed in the outer pipe, between the inner and outer pipes is defined outer discharge-irrigation channels, an inner discharge-irrigation channel is defined in the inner pipe which is triangle-shaped and rectangle-shaped in cross section, in a bottom of the outer pipe is defined a plurality of apertures, in both lateral surfaces and a bottom of the inner pipe are defined a plurality of apertures, the apertures defined in the lateral surfaces of the inner pipe enable the inner discharge-irrigation channel to be in communication with the outer discharge-irrigation channels, and the apertures defined in the bottom of the inner pipe are aligned with the apertures defined in the bottom of the outer pipe.

2. The convection type discharge-irrigation pipe as claimed in claim 1, wherein both ends of the inner discharge-irrigation channel of the inner pipe with a triangle-shaped cross section and the inner pipe with a rectangle-shaped cross section are sealed with a sealed head, respectively.

3. The convection type discharge-irrigation pipe as claimed in claim 1, wherein the inner pipe with a triangle-shaped cross section is solid and its lateral surfaces and bottom are defined with the apertures which are connected to one another via connecting holes.

4. The convection type discharge-irrigation pipe as claimed in claim 1, wherein the inner pipe with a rectangle-shaped cross section is solid and its lateral surfaces and bottom are defined with the apertures which are connected to one another via connecting holes.

5. The convection type discharge-irrigation pipe as claimed in claim 1, wherein separation ridges are formed on upper and lower portions of an inner periphery of the outer pipe, respectively, and are defined with insertion channels for insertion of waterproof plates, between the waterproof plates is the inner discharge-irrigation channel, between the waterproof plates and the inner periphery of the outer pipe are the outer discharge-irrigation channels, and a plurality of apertures is defined in an upper surface of the respective waterproof plates.

6. The convection type discharge-irrigation pipe as claimed in claim 1, wherein a row of vertical discharge-irrigation pipes are equidistantly arranged in an inner periphery of the outer pipe, and the respective discharge-irrigation pipes have a lower end connected to the apertures defined in the bottom of the outer pipe.

7. The convection type discharge-irrigation pipe as claimed in claim 6, wherein the respective discharges is defined with an open slot at a top end thereof.

8. The convection type discharge-irrigation pipe as claimed in claim 1, wherein the joint comprises a pipe head and a connecting block which is fixed inside the pipe head, and both ends of the connecting block are shaped corresponding to the shape of the inner pipe, such that the connecting block is inserted into or connected to the inner pipe.

9. The convection type discharge-irrigation pipe as claimed in claim 8, wherein the pipe head is selected from the group consisting of a cylindrical connection type pipe head, a cylindrical orthogonal-shaped pipe head, a cylindrical tee-shaped pipe head, a cylindrical seal-shaped pipe head and a cylindrical one-way connection type pipe head.

10. The convection type discharge-irrigation pipe as claimed in claim 9, wherein the cylindrical one-way connection type pipe head is defined with an inner hole having a dilated or reduced section, a sealed ball is disposed in the dilated or reduced section, and restriction blocks are disposed at one end of the dilated or reduced section.
